(19) United States
(12) Patent Application Publication
(10) Pub. No.: US 2011/0226503 A1
(43) Pub. Date: Sep. 22, 2011

(54) GAS INSULATED BUSBAR PARTICLE TRAP

(76) Inventors: Philip C. Bolin, Sewickley, PA (US); David F. Giegel, McDonald, PA (US); Dennis J. Matuszak, Seven Fields, PA (US); Douglas A. Herman, Sewickley, PA (US); Jay B. Sneddon, Cransberry Township, PA (US)

(21) Appl. No.: 12/906,800

(22) Filed: Oct. 18, 2010

Related U.S. Application Data
(60) Provisional application No. 61/314,943, filed on Mar. 17, 2010.

(51) Int. Cl. H01B 7/282

(52) U.S. Cl. 174/28

(57) ABSTRACT

A particle trap for a gas-insulated busbar (GIB) for high-voltage transmission systems. The particle trap is a circumferential cavity located and formed integral with a flanged end of the GIB's enclosure. In operation, particles present in a space between a central conductor and the enclosure of the GIB are guided to the particle trap by the presence of an electric field which exists between the central conductor and the grounded enclosure, and by the influences of gravity, mechanical vibration and gas flow. Once the particles enter the trap, the particles are immobilized.

### FIELD

The present invention relates to blocking devices that block the operation of switches, circuit breakers and other similar electrical equipment and, more particularly, to an electrically operated keyless blocking device.

### BACKGROUND

Gas-insulated busbars (GIB) are employed in high voltage transmission systems. As depicted in FIG. 1, a conventional GIB 10 typically comprises a grounded cylindrical hollow metallic enclosure 14 with an interior metallic cylindrical conductor 12 coaxially located in the center of the enclosure 14 by supports 16, i.e., triposts, made of insulating material. The space 15 between the inner conductor 12 and the enclosure 14 is filled with an insulating gas.

A potential problem for all GIBs is the presence of contaminants such as foreign particles, conducting or semi-conducting, in the space between the inner conductor and the enclosure. Such particles have the potential of causing electrical breakdown within the GIB. In order to prevent electrical breakdown from foreign particles present in the space between the inner conductor and the enclosure, GIBs typically include a particle trap.

As depicted in FIG. 2, a particle trap 20 is shown mounted adjacent the supports 16 using mounting straps 21 to attach it to the enclosure 14. This and other conventional particle traps have their drawbacks. They include additional individual parts that can be assembled incorrectly in the GIB as well as break, come loose, or be accidentally left out of the final GIB assembly.

It is desirable to provide a particle trap that is less costly and complex, and more reliable than conventional particle traps.

### SUMMARY

Embodiments provided herein are directed to a particle trap for gas-insulated busbars (GIB) for high voltage transmission systems that tends to be less expensive than conventional particle traps since there are no additional parts, cannot be assembled incorrectly, and that cannot break, cannot come loose, and cannot be accidentally left out when assembling the GIB. In a preferred embodiment, a particle trap comprises a circumferential cavity located and formed integral with a flanged end of a GIB's enclosure. In operation, particles present in the space between a central conductor and the enclosure of the GIB are guided to the particle trap by the presence of an electric field which exists between the central conductor and the grounded enclosure, and by the influences of gravity, mechanical vibration and gas flow. The particles levitate cyclically with an applied alternating voltage and migrate along the length of the enclosure. Once the particles enter the trap, they are immobilized in operation due to the low electrical field at the ends of the enclosure.

Other systems, methods, features and advantages of the example embodiments will be or will become apparent to one with skill in the art upon examination of the following figures and detailed description.

### BRIEF DESCRIPTION OF FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a perspective view of a conventional gas-insulated busbar.

FIG. 2 is a plan sectional view of conventional gas-insulated busbar with a particle trap.

FIG. 3 is a perspective view of a preferred embodiment of a gas-insulated busbar with a particle trap formed in the flanged end of the enclosure of the gas-insulated busbar.

FIG. 4 is a perspective view of the flange of the gas-insulated busbar.

FIG. 5 is a plan sectional view of the flange of the gas-insulated busbar.

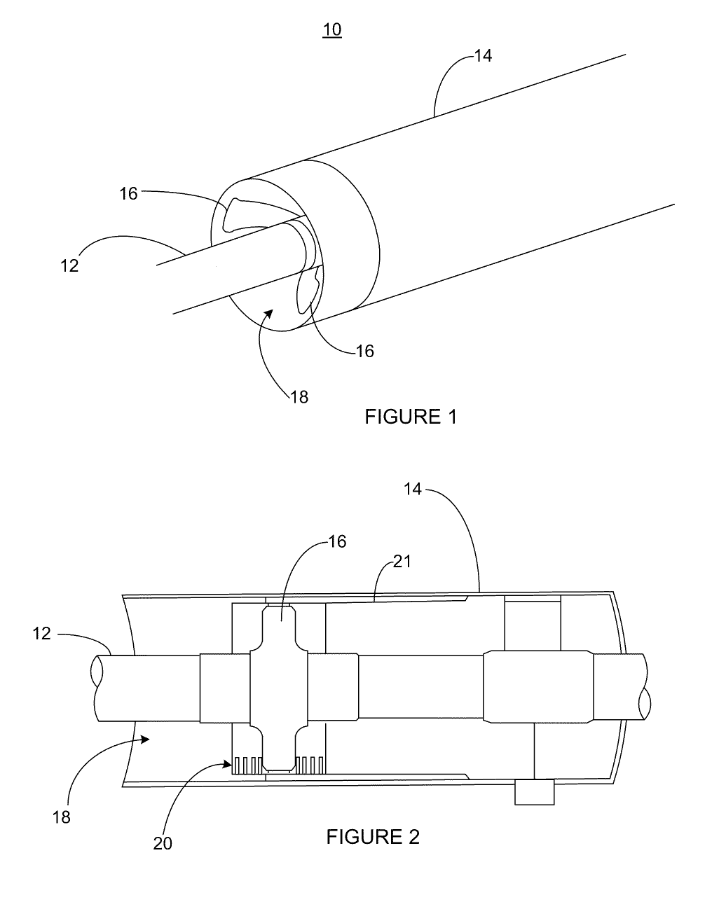

It should be noted that elements of similar structures or functions are generally represented by like reference numerals for illustrative purpose throughout the figures. It should also be noted that the figures are only intended to facilitate the description of the preferred embodiments.

### DESCRIPTION

Each of the additional features and teachings disclosed below can be utilized separately or in conjunction with other features and teachings to produce a particle trap for gas-insulated busbar for high voltage transmission systems. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

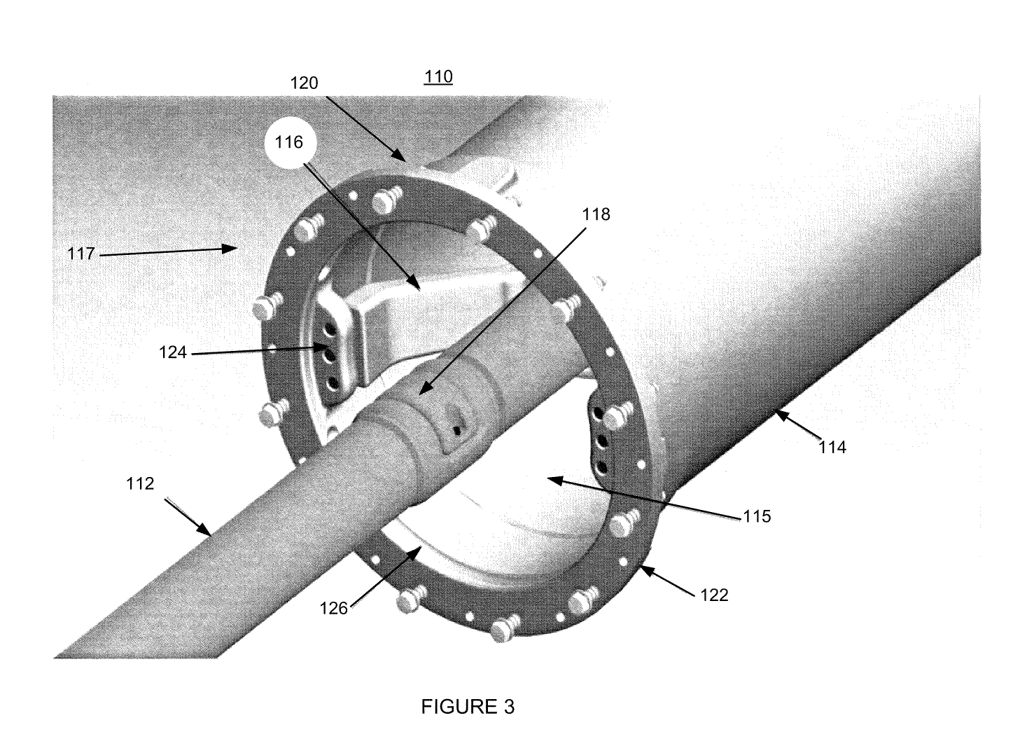

An improved particle trap for gas-insulated busbars (GIB) for high voltage transmission systems that tends to be less expensive than conventional particle traps since there are no additional parts, and that cannot be assembled incorrectly, cannot break, cannot come loose, and cannot be accidentally left out when assembling the GIB. Referring in detail to the figures, FIG. 3 shows a preferred embodiment of a GIB 110 that is provided with a particle trap which captures foreign particles, conducting and semi-conducting, that are present in the GIB 110, preventing them from causing electrical breakdown in the GIB 110.

As depicted in FIG. 3, the GIB 110 preferably includes a grounded cylindrical hollow metallic enclosure 114 with an interior metallic cylindrical conductor 112 coaxially located in the center of the enclosure 114 by supports 116 made of insulating material. The space 115 between the inner conductor 112 and the enclosure 114 is filled with an insulating gas. A contact assembly 118 enables coupling of two sections of the central conductor 112. The enclosure 114 preferably includes a flanged end 117 or a flanged coupling 120 attached to the end of the enclosure 114 to enable coupling of two sections of the enclosure 114.

A particle trap 126 preferably comprises a circumferential cavity or groove located and formed integral to the flanged end 117 of the enclosure 114. The particle trap 126 is shown as a u-shape, although the trap may also be a flat bottom shape, or a v-shape. The particle trap 126 may comprise a contiguous circumferential cavity or may comprise two or more circumferentially co-axial cavities.

Pedestals 124 may be mounted in the cavity 126 or coupled to the surface of the enclosure to enable the mounting of the supports of insulating material that support the central conductor 112.

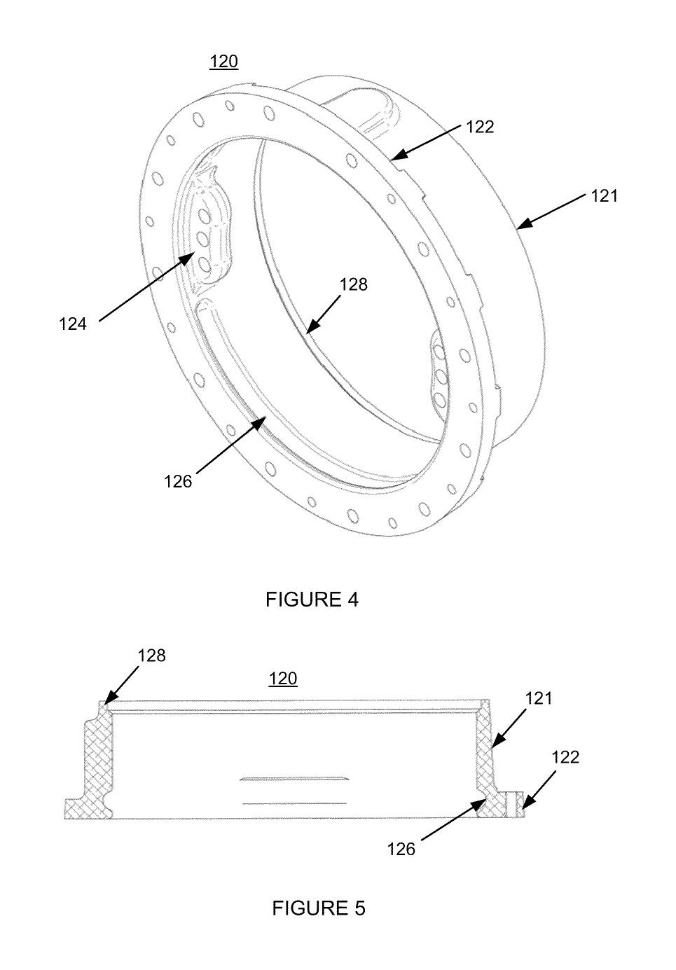

Referring to FIGS. 4 and 5, the flanged coupling 120 preferably includes a cylindrical body 121, a flange 122 radially extending from one end of the body 121, and a circumferential coupling groove 128 formed in the end of the body 121 opposite the flanged end. An end of the enclosure 114 is received in the coupling groove 128 to attach the flanged coupling 120 to the enclosure 114 by welding or other method. The particle trap 126 is located adjacent and formed integrally in the flanged end of the body 121. The flanged coupling 120 and integrally formed particle trap 126 may be cast or formed using other methods known in the art.

In operation, the central conductor 112 is energized with an applied alternating voltage, generating an electric field between the central conductor 112 and the grounded enclosure 114, and an insulating gas is present in the space 118 between the central conductor 112 and the enclosure 114. Particles present in the space 118 between the central conductor 112 and the enclosure 114 are guided to the particle trap 126 by the presence of the electric field, the influences of gravity, and mechanical vibration. The particles levitate cyclically with the applied alternating voltage, and migrate along the length of the enclosure. The central conductor 112 tends to sag due to gravity which causes a higher electrical field at the center of the enclosure 114 than at the ends of the enclosure 114. The differential in the electrical field combined with the cyclical levitation causes particles to move toward the trap(s) 126 at the ends of the enclosure 114. Once the particles enter the particle trap 126, they are immobilized due to the low electrical field in the particle trap 126, i.e., the particles cannot acquire enough energy from the electrical field in the particle trap 126 to escape the particle trap 126.

To enhance the effectiveness of the particle trap 126, an adhesive may be applied in the particle trap 126 to further immobilize the particles.

Although the GIB 110 can be oriented at any angle, the trap 126 is only effective in trapping the particles up to the point where particles spill out of the trap 126. When the GIB 110 is oriented in a vertical plane, the particles will fall along the length of the enclosure 114 until they land on a horizontal bottom, at which point the traps 126 function as explained above.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

1. A gas insulated bus bar comprising
an elongate cylindrical enclosure comprising a flanged end, and
a cylindrical conductor coaxially located in the center of the enclosure, a space between the inner conductor and the enclosure is fillable with an insulating gas,
a particle trap formed integral to the flanged end of the enclosure.

2. The gas insulated bus bar of claim 1 wherein the particle trap is a circumferential cavity formed in the flanged end.

3. The gas insulated bus bar of claim 1 wherein the particle trap is a circumferential groove.

4. The gas insulated bus bar of claim 1 wherein the particle trap is u-shape.

5. The gas insulated bus bar of claim 1 wherein the particle trap is v-shape.

6. The gas insulated bus bar of claim 1 wherein the particle trap has a flat bottom shape.

7. The gas insulated bus bar of claim 2 wherein the circumferential cavity is contiguous about the periphery of the flange end.

8. The gas insulated bus bar of claim 2 wherein the circumferential cavity comprises two or more circumferentially co-axial cavities.

9. The gas insulated bus bar of claim 3 wherein the circumferential groove is contiguous about the periphery of the flange end.

10. The gas insulated bus bar of claim 3 wherein the circumferential groove comprises two or more circumferentially co-axial groove.

11. The gas insulated bus bar of claim 1 wherein the flanged end includes flanged coupling coupled to the enclosure.

12. The gas insulated bus bar of claim 11 wherein the flanged coupling includes a cylindrical body, a flange radially extending from one end of the body.

13. The gas insulated bus bar of claim 1 wherein the particle trap may include an adhesive.
